(19) United States
(12) Patent Application Publication
(10) Pub. No.: US 2024/0356203 A1
(43) Pub. Date: Oct. 24, 2024

(54) APPARATUS, SYSTEM, AND METHOD FOR INTEGRATING ANTENNAS THAT SUPPORT MULTIPLE WIRELESS TECHNOLOGIES INTO EYEWEAR FRAMES OF ARTIFICIAL-REALITY DEVICES

(71) Applicant: Meta Platforms Technologies, LLC, Menlo Park, CA (US)

(72) Inventors: Nil Apaydin, Kirkland, WA (US); Vignesh Manohar, Ontario (CA); Javier Rodriguez De Luis, Kirkland, WA (US); Chia-Ching Lin, San Jose, CA (US); Huan Liao, San Jose, CA (US); Liang Han, Sunnyvale, CA (US)

(21) Appl. No.: 18/302,327

(22) Filed: Apr. 18, 2023

(51) Int. Cl. H01Q 1/27; G02B 27/01; H01Q 21/30

(52) U.S. Cl. CPC H01Q 1/273; G02B 27/0176; H01Q 21/30; G02B 2027/0178

(57) ABSTRACT

An artificial-reality device comprising (1) an eyewear frame dimensioned to be worn by a user and (2) a plurality of antennas coupled to the eyewear frame, wherein the plurality of antennas comprise (A) a first antenna configured to support a first wireless technology, (B) a second antenna configured to support a second wireless technology, and (C) a third antenna configured to support a third wireless technology. Various other apparatuses, systems, and methods are also disclosed.

### BRIEF DESCRIPTION OF DRAWINGS

The accompanying Drawings illustrate a number of exemplary embodiments and are parts of the specification. Together with the following description, the Drawings demonstrate and explain various principles of the instant disclosure.

FIG. 1 is an illustration of an exemplary artificial-reality device equipped with antennas that support multiple wireless technologies according to one or more embodiments of this disclosure.

FIG. 2 is an illustration of an additional exemplary artificial-reality device equipped with antennas that support multiple wireless technologies according to one or more embodiments of this disclosure.

FIG. 3 is an illustration of an additional exemplary artificial-reality device equipped with antennas that support multiple wireless technologies according to one or more embodiments of this disclosure.

FIG. 4 is an illustration of an additional exemplary artificial-reality device equipped with antennas that support multiple wireless technologies according to one or more embodiments of this disclosure.

FIG. 5 is an illustration of a portion of an exemplary artificial-reality device equipped with antennas that support multiple wireless technologies according to one or more embodiments of this disclosure.

FIG. 6 is an illustration of an additional exemplary artificial-reality device equipped with antennas that support multiple wireless technologies according to one or more embodiments of this disclosure.

FIG. 7 is a flowchart of an exemplary method for integrating antennas that support multiple wireless technologies into artificial-reality devices according to one or more embodiments of this disclosure.

FIG. 8 is an illustration of exemplary AR system that may be used in connection with embodiments of this disclosure.

FIG. 9 is an illustration of an exemplary VR system that may be used in connection with embodiments of this disclosure.

FIG. 10 is an illustration of exemplary haptic devices that may be used in connection with embodiments of this disclosure.

FIG. 11 is an illustration of an exemplary VR environment according to embodiments of this disclosure.

FIG. 12 is an illustration of an exemplary AR environment according to embodiments of this disclosure.

While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION

The present disclosure is generally directed to apparatuses, systems, and methods for integrating antennas that support multiple wireless technologies into eyewear frames of artificial-reality devices. As will be explained in greater detail below, these apparatuses, systems, and methods may provide numerous features and benefits.

Artificial reality may provide a rich, immersive experience in which users are able to interact with virtual objects and/or environments in one way or another. In this context, artificial reality may constitute and/or represent a form of reality that has been altered by virtual objects for presentation to a user. Such artificial reality may include and/or represent virtual reality (VR), augmented reality (AR), mixed reality, hybrid reality, or some combination and/or variation of one or more of the same.

The apparatuses, systems, and methods described herein may provide, facilitate, and/or represent new artificial-reality architectures that reduce and/or decrease the number of devices needed and/or relied on to achieve the full potential of a user's artificial-reality experience. As a specific example, one AR architecture may be implemented as a 2-device or 3-device system that includes and/or represents an AR headset, a wearable device, and/or a compute puck. In this example, the 2-device or 3-device AR architecture may facilitate and/or support multiple wireless technologies, such as WI-FI, BLUETOOTH, cellular, and/or global navigation satellite system (GNSS) communications. The apparatuses, systems, and methods described herein may reduce and/or decrease the number of devices needed and/or relied on from such 2-device or 3-device AR architectures to a new 1-device AR architecture. In other words, this new 1-device AR architecture may effectively obviate the need for the wearable device and/or the compute puck to achieve the full potential of a user's AR experience.

In some examples, the 1-device AR architecture may include and/or represent AR eyeglasses that facilitate and/or support direct connections to various systems (e.g., WI-FI, BLUETOOTH, cellular, and/or GNSS) via several integrated antennas. In one example, a pair of AR eyeglasses may include and/or represent WI-FI antennas integrated into the temples, a BLUETOOTH antenna integrated into one of the temples, cellular antennas integrated into the front frame (e.g., rim) and the lenses, and/or a GNSS antenna integrated into the front frame. In another example, a pair of AR eyeglasses may include WI-FI antennas integrated into the temples and the front frame (e.g., rim), a BLUETOOTH antenna integrated into the front frame, cellular antennas integrated into the front frame and the lenses, and/or a GNSS antenna integrated into the front frame.

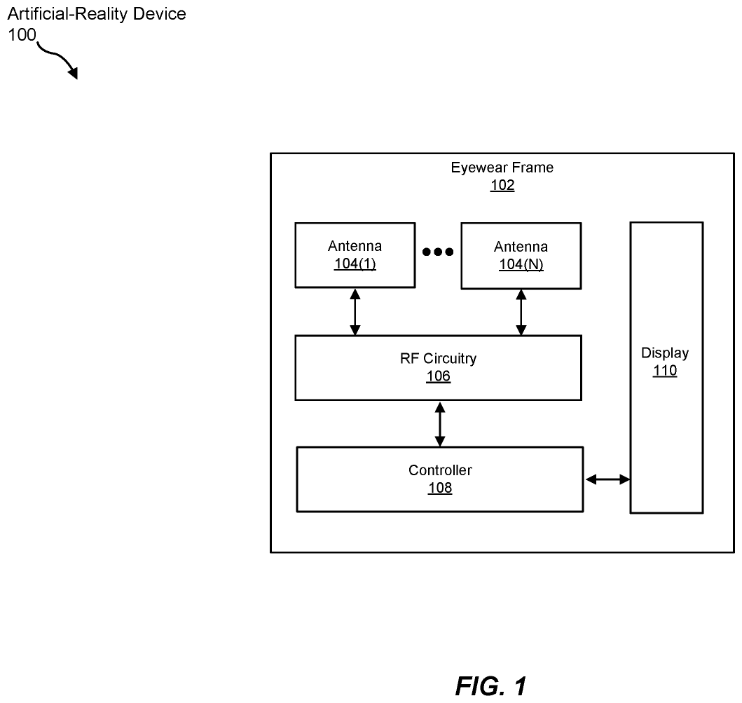

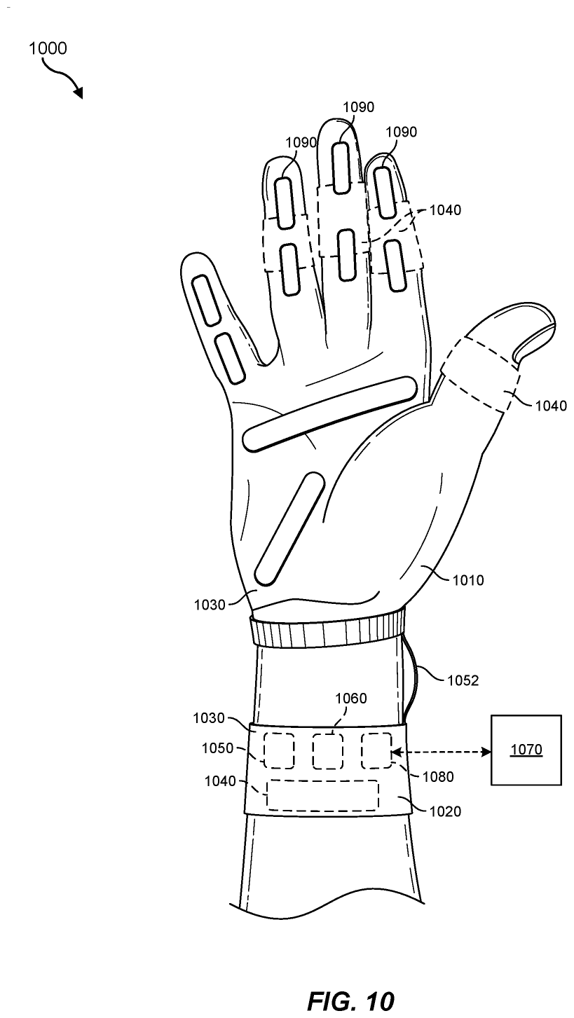

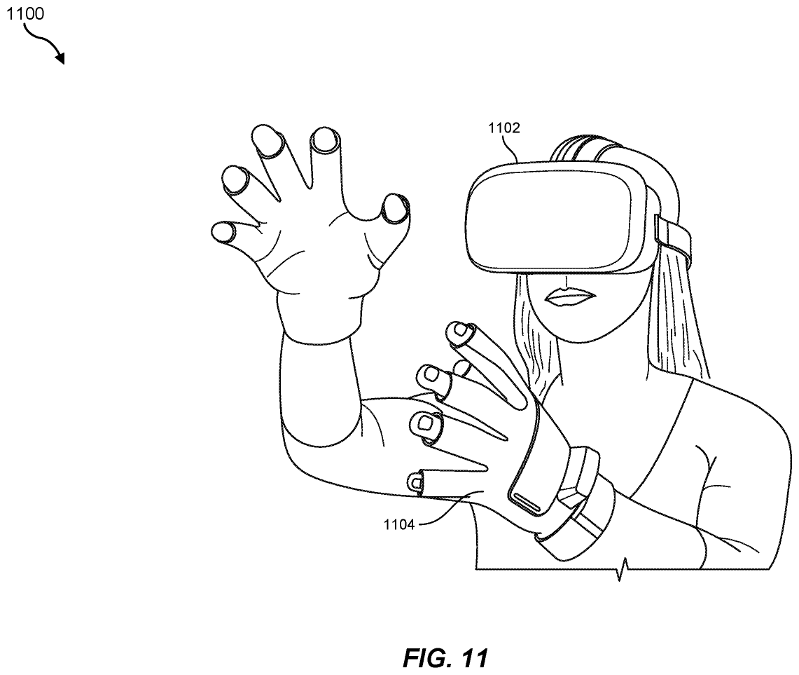

The following will provide, with reference to FIGS. 1-9, detailed descriptions of exemplary apparatuses, devices, systems, components, and corresponding configurations for integrating antennas that support multiple wireless technologies into eyewear frames of artificial-reality devices. In addition, detailed descriptions of methods for integrating antennas that support multiple wireless technologies into eyewear frames of artificial-reality devices in connection with FIG. 10. The discussion corresponding to FIGS. 11-14 will provide detailed descriptions of types of exemplary artificial-reality devices, wearables, and/or associated systems capable of integrating antennas that support multiple wireless technologies into eyewear frames of artificial-reality devices.

FIG. 1 illustrates portions of an exemplary artificial-reality device 100 that integrates antennas that support multiple wireless technologies. As illustrated in FIG. 1, artificial-reality device 100 may include and/or represent an eyewear frame 102 and/or antennas 104(1)-(N). In some examples, eyewear frame 102 may be dimensioned and/or configured to be donned or worn by a user. In such examples, antennas 104(1)-(N) may be coupled to eyewear frame 102. In one example, antennas 104(1)-(N) may collectively provide, facilitate, and/or support various wireless technologies (e.g., WI-FI, BLUETOOTH, cellular, GNSS, etc.).

As illustrated in FIG. 1, artificial-reality device 100 may also include and/or represent various other devices, components, and/or features that facilitate and/or support the user's experience. For example, artificial-reality device 100 may include and/or represent radio-frequency (RF) circuitry 106, a controller 108, and/or a display 110. In this example, RF circuitry 106 may be electrically and/or communicatively coupled to antennas 104(1)-(N) and/or controller 108. Additionally or alternatively, controller 108 may be electrically and/or communicatively coupled to display 110. In certain implementations, the wireless technologies supported by antennas 104(1)-(N) and/or RF circuitry 106 may direct, influence, and/or control certain features (e.g., virtual features, dimming features, audio features, etc.) of artificial-reality device 100 in connection with the user's experience.

In some examples, artificial-reality device 100 may include and/or represent any type of electronic display and/or visual device that is worn on or mounted to the user's head or face and/or provides artificial-reality experiences. In one example, artificial-reality device 100 may include and/or represent a pair of AR glasses designed to be worn on and/or secured to the user's head or face. In this example, artificial-reality device 100 may include and/or represent eyewear frame 102 fitted and/or equipped with display 110.

In some examples, eyewear frame 102 may include and/or represent any type or form of structure and/or assembly capable of securing and/or mounting artificial-reality device 100 to the user's head or face. In one example, eyewear frame 102 may be sized and/or shaped in any suitable way to facilitate securing and/or mounting artificial-reality device 100 to the user's head or face. In one example, eyewear frame 102 may include and/or contain a variety of different materials. For example, eyewear frame 102 may include and/or represent one or more metals (e.g., magnesium) capable of forming antennas for radiating RF signals. Additional examples of such materials include, without limitation, plastics, acrylics, polyesters, nylons, conductive, rubbers, neoprene, carbon fibers, composites, combinations or variations of one or more of the same, and/or any other suitable materials.

In some examples, antennas 104(1)-(N) may each include and/or represent any type or form of device and/or interface that facilitates and/or supports the propagation of radio waves between metal conductors and/or space (e.g., air). In one example, antennas 104(1)-(N) may each include and/or represent part of at least one radio that transmits and/or receives communications via space. In this example, the radio may include and/or represent various other components as well, including RF circuitry 106.

In some examples, antennas 104(1)-(N) may each include and/or represent any type or form of material and/or substance capable of radiating RF energy for transmitting and/or receiving RF communications. Examples of materials used to form antennas 104(1)-(N) include, without limitation, magnesiums, coppers, aluminums, steels, stainless steels, silvers, golds, combinations or variations of one or more of the same, and/or any other suitable materials.

In some examples, RF circuitry 106 may include and/or represent one or more circuits designed to produce, carry, transmit, receive, process, and/or otherwise use wireless signals within the RF band and/or spectrum. For example, RF circuitry 106 may include and/or represent all or a portion of an RF integrated circuit (RFIC) incorporated in artificial-reality device 100. In this example, the RFIC may contain and/or implement various components that support and/or facilitate RF communications via antennas 104(1)-(N). Examples of such RF components include, without limitation, signal generators, filters, transmission lines, waveguides, radios, mixers, amplifiers, oscillators, couplers, detectors, combiners, receivers, transmitters, transceivers, tuners, modulators, demodulators, shielding, circuit boards, transistors, processors, resistors, capacitors, diodes, inductors, switches, registers, flipflops, connections, ports, antenna ports, RF frontends, portions of one or more of the same, combinations or variations of one or more of the same, and/or any other suitable components.

In some examples, controller 108 may include and/or represent any type or form of hardware-implemented processing device and/or component capable of interpreting and/or executing computer-readable instructions. Controller 108 may access, execute, and/or modify certain software and/or firmware modules to support and/or facilitate wireless technologies in connection with artificial-reality device 100. In one example, controller 108 may include and/or represent multiple circuits distributed within artificial-reality device 100 and/or combined to form a processing system. Examples of controller 108 include, without limitation, physical processors, processing circuitry, central processing units (CPUs), microprocessors, microcontrollers, field-programmable gate arrays (FPGAs), application-specific integrated circuits (ASICs), systems on a chip (SoCs), parallel accelerated processors, tensor cores, integrated circuits, chiplets, portions of one or more of the same, variations or combinations of one or more of the same, and/or any other suitable controller.

In some examples, display 110 may include and/or represent any type or form of electronic display device, screen, and/or projector capable of presenting, delivering, and/or providing visual information, images, light, and/or virtual features to the user. For example, display 110 may include and/or represent one or more screens, lenses, and/or corresponding partially see-through components integrated and/or incorporated into a pair of AR glasses. In one example, display 110 may include and/or represent a light crystal display (LCD) display that spatially modulates light intensity. In this example, the LCD display may emit light capable of forming images and/or virtual features destined for one or more of the user's eyes. Additional examples of display 110 include, without limitation, light-emitting diodes (LEDs), microLEDs, organic LEDs (OLEDs), active-matrix OLEDs (AMOLEDs), a scanned display (e.g., a 2-dimensional scanned laser), a projected LCD, a backlit LCD, a liquid crystal on silicon (LCoS) display, a ferroelectric LCOS (FLCOS) display, a flexible display, portions of one or more of the same, combinations or variations of one or more of the same, and/or any other suitable display.

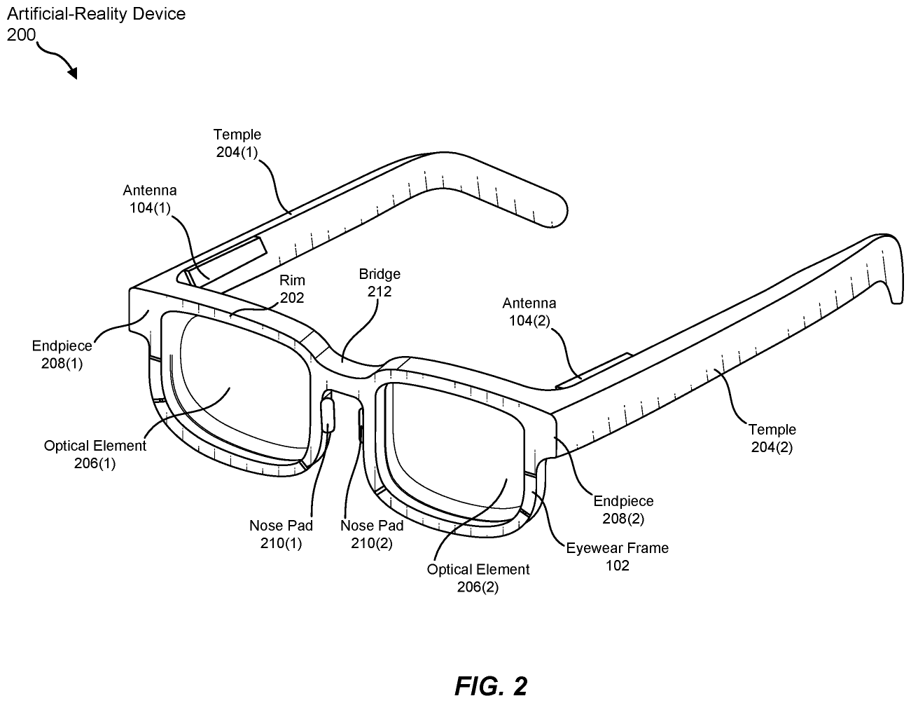

FIG. 2 illustrates portions of an exemplary artificial-reality device 200 that integrates antennas that support multiple wireless technologies. In some examples, artificial-reality device 200 may include and/or represent certain components, configurations, and/or features that perform and/or provide functionalities that are similar and/or identical to those described above in connection with FIG. 1. As illustrated in FIG. 2, artificial-reality device 200 may include and/or represent eyewear frame 102 composed of a rim 202, temples 204(1) and 204(2), endpieces 208(1) and 208(2), nose pads 210(1) and 210(2), and/or a bridge 212.

In some examples, artificial-reality device 200 may also include and/or represent optical elements 206(1) and 206(2) that are coupled to, incorporated in, and/or held by eyewear frame 102. In one example, optical elements 206(1)-(2) may constitute and/or represent a specific implementation of display 110 in FIG. 1. In this example, optical elements 206(1)-(2) may be configured to provide one or more virtual features for presentation to a user wearing artificial-reality device 200. These virtual features may be driven, influenced, and/or controlled by one or more wireless technologies supported by artificial-reality device 200.

In some examples, optical elements 206(1)-(2) may each include and/or represent optical stacks, lenses, and/or films. In one example, optical elements 206(1)-(2) may include and/or represent various layers that facilitate and/or support the presentation of virtual features and/or elements that overlay real-world features and/or elements. Additionally or alternatively, optical elements 206(1)-(2) may include and/or represent one or more screens, lenses, and/or fully or partially see-through components. Examples of optical elements 206(1)-(2) include, without limitation, electrochromic layers, dimming stacks, transparent conductive layers (such as indium tin oxide films), metal meshes, antennas, transparent resin layers, lenses, films, combinations or variations of one or more of the same, and/or any other suitable optical elements.

In some examples, artificial-reality device 200 may further include and/or represent antennas 104(1) and 104(2) that are designed, configured, and/or arranged to support different wireless technologies. Examples of such wireless technologies include, without limitation, cellular circuitry or communications, wireless local area network (WLAN) circuitry or communications, short-range communications or corresponding circuitry, satellite communications or corresponding circuitry, WI-FI circuitry or communications, BLUETOOTH circuitry or communications, GNSS circuitry or communications, combinations or variations of one or more of the same, and/or any other suitable wireless technologies. In one example, artificial-reality device 200 may include and/or represent one or more additional antennas that are not necessarily illustrated and/or labelled in FIG. 2.

In one example, artificial-reality device 200 may constitute, represent, and/or form part of a WLAN that supports WI-FI communications via one or more of antennas 104(1)-(N). In this example, the WLAN communications may be implemented via one or more WI-FI protocols and/or standards. In another example, artificial-reality device 200 may constitute, represent, and/or form part of a short-range pairing that supports BLUETOOTH communications via one or more of antennas 104(1)-(N). In this example, the short-range communications may be implemented via one or more BLUETOOTH protocols and/or standards. In a further example, artificial-reality device 200 may receive GNSS communications from one or more satellites. In this example, the satellite communications may be implemented via one or more GNSS protocols and/or standards.

In some examples, antennas 104(1)-(2) may be positioned along and/or coupled to temples 204(1)-(2), respectively. In one example, antennas 104(1)-(2) may be fully or partially incorporated and/or integrated in temples 204(1)-(2), respectively. For example, antennas 104(1)-(2) may be packaged and/or housed in corners of eyewear frame 102 formed by rim 202 and temples 204(1)-(2), respectively. In this example, rim 202 may include and/or incorporate endpieces 208(1)-(2), and antennas 104(1)-(2) may be packaged and/or housed in corners of eyewear frame 102 formed by endpieces 208(1)-(2) and temples 204(1)-(2), respectively.

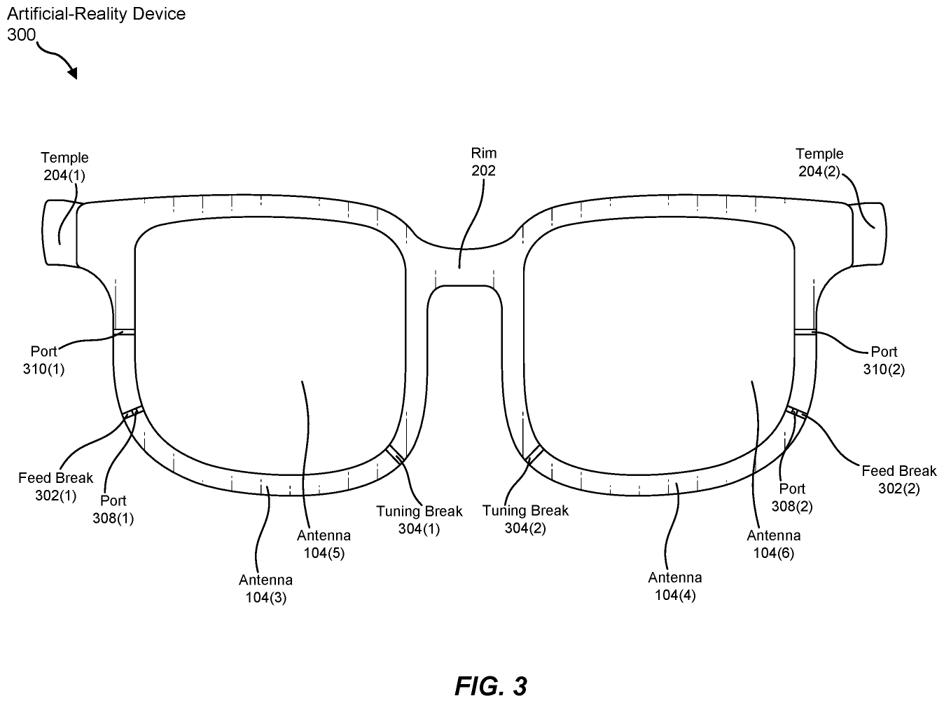

FIG. 3 illustrates portions of an exemplary artificial-reality device 300 that integrates antennas that support multiple wireless technologies. In some examples, artificial-reality device 300 may include and/or represent certain components, configurations, and/or features that perform and/or provide functionalities that are similar and/or identical to those described above in connection with FIG. 1 and/or FIG. 2. For example, in addition to the various components and/or features illustrated in FIG. 3, artificial-reality device 300 may also include and/or represent antennas 104(1)-(2) as described above in connection with FIG. 2 even though antennas 104(1)-(2) are not necessarily illustrated and/or labelled in FIG. 3.

As illustrated in FIG. 3, artificial-reality device 300 may include and/or represent antennas 102(3), 102(4), 102(5), and 102(6) designed, configured, and/or arranged to support different wireless technologies. In some examples, antennas 104(3)-(4) may include and/or represent different segments, pieces, and/or portions of rim 202. For example, antennas 104(3)-(4) may be formed from segments included in rim 202. In one example, antenna 104(3) may constitute and/or represent a segment formed along a bottom section of rim 202 that secures, envelops, and/or holds optical element 206(1). Additionally or alternatively, antenna 104(4) may constitute and/or represent a segment formed along a bottom section of rim 202 that secures, envelops, and/or holds optical element 206(2).

In some examples, antennas 104(5)-(6) may include and/or represent one or more components, features, and/or portions of optical elements 206(1)-(2), respectively. For example, antennas 104(5)-(6) may each be formed, created, and/or implemented by one or more transparent conductive and/or radiating layers included in optical elements 206(1)-(2). In one example, antennas 104(5)-(6) may each include and/or represent an indium tin oxide (ITO) layer and/or film incorporated and/or disposed in optical elements 206(1)-(2). In this example, the ITO layer may carry or convey electrical signals and/or stimuli that excite a metal mesh antenna for wireless communications.

Additionally or alternatively, antennas 104(5)-(6) may each include and/or represent a metal mesh disposed and/or applied as a part of and/or inside a film coupled to one or more see-through lenses of artificial-reality device 300. In some examples, a metal mesh antenna may each include and/or represent a network of wires and/or threads. In one example, the metal mesh antenna may include and/or represent lattices and/or webbings of similar, identical, varied, gradient, and/or random sizes. For example, the metal mesh antenna may include and/or form various honeycomb-shaped lattices and/or structures that are nearly invisible to the naked eye.

In some examples, in addition to the various antennas, artificial-reality device 300 may also include and/or represent various other components, devices, and/or features that support and/or facilitate the wireless technologies. In one example, artificial-reality device 300 may include and/or represent one or more RF frontends that are electrically and/or communicatively coupled to antennas 104(3)-(6) via antenna feeds (e.g., coaxial cables). Additionally or alternatively, artificial-reality device 300 may also include and/or represent one or more antenna ports, such as ports 308(1)-(2) and 310(1)-(2). In one example, the antenna feeds may provide, inject, and/or deliver RF signals to antennas 104(3)-(6) at and/or via ports 308(1)-(2) and 310(1)-(2), respectively.

In some examples, artificial-reality device 300 may also include and/or represent one or more feed breaks, such as feed breaks 302(1)-(2). In one example, feed breaks 302(1)-(2) may each include and/or represent an electrical discontinuity, disconnect, and/or dielectric along rim 202. In this example, one side of feed breaks 302(1)-(2) may include and/or represent antennas 102(3)-(4), respectively. The other side of feed breaks 302(1)-(2) may include and/or represent a ground reference, signal, and/or plane. Accordingly, feed breaks 302(1)-(2) may separate and/or electrically isolate antenna 104(3)-(4) from the ground reference, signal, and/or plane.

In some examples, artificial-reality device 300 may also include and/or represent one or more tuning breaks, such as tuning breaks 304(1)-(2). In one example, tuning breaks 304(1)-(2) may each excite, cause, and/or implement a certain mode for antennas 104(3)-(4), respectively. For example, tuning breaks 304(1)-(2) may each be tuned, configured, and/or designed to excite lower order modes for low-band antennas and/or radiation. Additionally or alternatively, tuning breaks 304(1)-(2) may each be tuned, configured, and/or designed to excite higher order modes for middle-band and/or high-band antennas or radiation.

As illustrated in FIG. 3, feed break 302(1) may be formed, created, and/or applied along an outer middle section of rim 202 proximate to endpiece 208(1). Additionally or alternatively, feed break 302(2) may be formed, created, and/or applied along an outer middle section of rim 202 proximate to endpiece 208(2). Accordingly, feed breaks 302(1)-(2) may be formed, created, and/or applied in similar locations on opposite sides and/or ends of rim 202 relative to one another.

As illustrated in FIG. 3, tuning break 304(1) may be formed, created, and/or applied along an inner bottom section of rim 202 between nose pad 210(1) and feed break 302(1). Additionally or alternatively, tuning break 304(2) may be formed, created, and/or applied along an inner bottom section of rim 202 between nose pad 210(2) and feed break 302(2). Accordingly, tuning breaks 304(1)-(2) may be formed, created, and/or applied in similar locations on opposite sides of bridge 212 relative to one another.

In some examples, the ports, feed breaks, tuning breaks, and/or antenna feeds may be placed and/or positioned to maximize and/or optimize their respective distances from a user's head wearing artificial-reality device 300. Such placements and/or positions may reduce, minimize, and/or mitigate the amount of RF radiation absorbed by the user's head from those ports, feed breaks, tuning breaks, and/or antenna feeds. Additionally or alternatively, such placements and/or positions may increase and/or improve the performance and/or efficiency of the antennas.

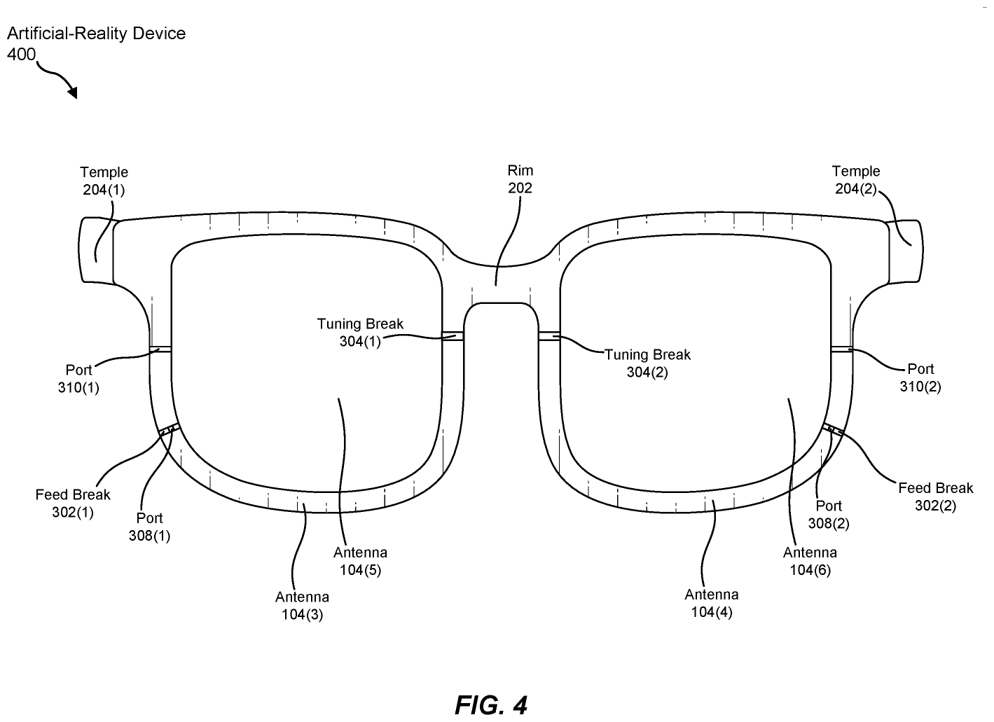

FIG. 4 illustrates portions of an exemplary artificial-reality device 400 that integrates antennas that support multiple wireless technologies. In some examples, artificial-reality device 400 may include and/or represent certain components, configurations, and/or features that perform and/or provide functionalities that are similar and/or identical to those described above in connection with any of FIGS. 1-3. For example, in addition to the various components and/or features illustrated in FIG. 4, artificial-reality device 400 may also include and/or represent antennas 104(1)-(2) as described above in connection with FIG. 2 even though antennas 104(1)-(2) are not necessarily illustrated and/or labelled in FIG. 4.

As illustrated in FIG. 4, tuning break 304(1) may be formed, created, and/or applied along an inner top section of rim 202 proximate nose pad 210(1) of eyewear frame 102. Additionally or alternatively, tuning break 304(2) may be formed, created, and/or applied along an inner top section of rim 202 proximate nose pad 210(2) of eyewear frame 102.

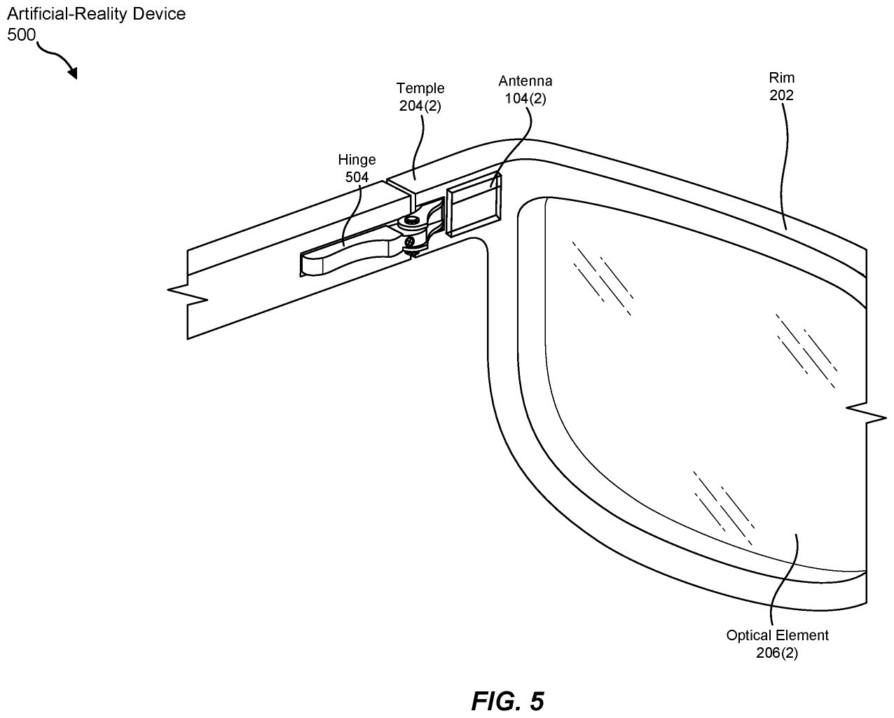

FIG. 5 illustrates portions of an exemplary artificial-reality device 500 that integrates multiple antennas to support multiple wireless technologies. In some examples, artificial-reality device 500 may include and/or represent certain components, configurations, and/or features that perform and/or provide functionalities that are similar and/or identical to those described above in connection with any of FIGS. 1-4. In one example, artificial-reality device 500 may include and/or represent antenna 104(2) integrated and/or incorporated into temple 204(2) of eyewear frame 102. In this example, antenna 104(2) may be communicatively and/or electrically coupled to an RF frontend via an antenna feed (e.g., a coaxial cable).

In some examples, antenna 104(2) and/or the antenna feed may be packaged and/or housed in a compartment and/or extension of temple 204(2). In one example, this compartment and/or extension of temple 204(2) may be placed and/or positioned proximate to a corner formed between temple 204(2) and rim 202. For example, antenna 104(2) and/or the antenna feed may be installed and/or inserted within a compartment and/or extension of temple 204(2) positioned between rim 202 and a hinge 504.

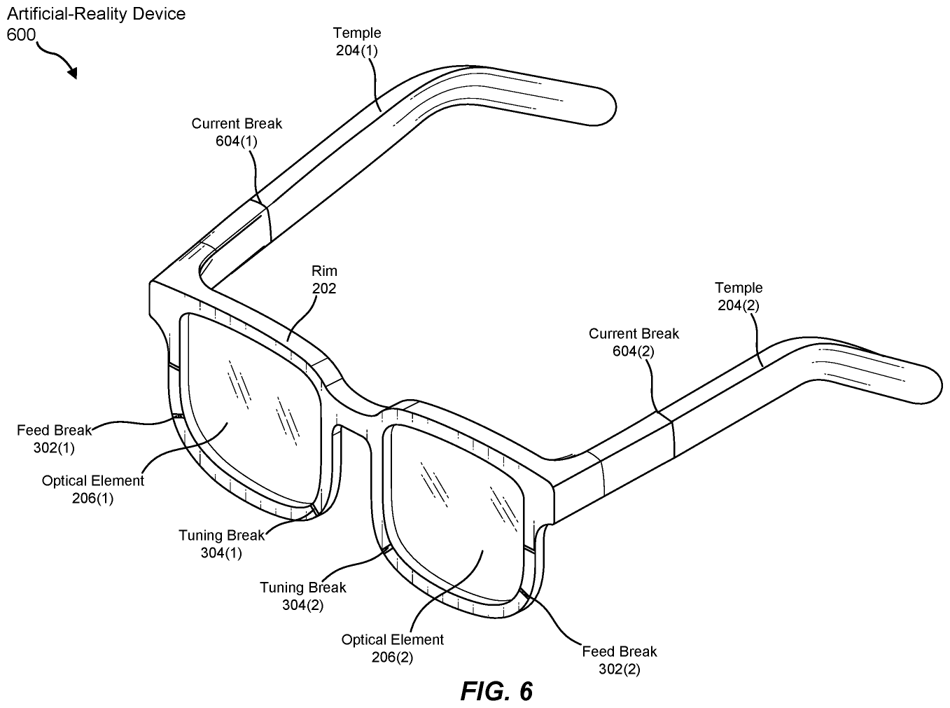

FIG. 6 illustrates portions of an exemplary artificial-reality device 600 that integrates antennas that support multiple wireless technologies. In some examples, artificial-reality device 600 may include and/or represent certain components, configurations, and/or features that perform and/or provide functionalities that are similar and/or identical to those described above in connection with any of FIGS. 1-5. For example, in addition to the various components and/or features illustrated in FIG. 6, artificial-reality device 600 may also include and/or represent antennas 104(1)-(6) as described above in connection with FIGS. 1-5 even though antennas 104(1)-(6) are not necessarily illustrated and/or labelled in FIG. 6.

As illustrated in FIG. 6, feed break 302(1) may be formed, created, and/or applied along an outer middle section of rim 202 proximate to endpiece 208(1). Additionally or alternatively, feed break 302(2) may be formed, created, and/or applied along an outer middle section of rim 202 proximate to endpiece 208(2). Accordingly, feed breaks 302(1)-(2) may be formed, created, and/or applied in similar locations on opposite sides and/or ends of rim 202 relative to one another.

As illustrated in FIG. 6, tuning break 304(1) may be formed, created, and/or applied along a middle bottom section of rim 202 between nose pad 210(1) and feed break 302(1). Additionally or alternatively, tuning break 304(2) may be formed, created, and/or applied along a middle bottom section of rim 202 between nose pad 210(2) and feed break 302(2). Accordingly, tuning breaks 304(1)-(2) may be formed, created, and/or applied in similar locations on opposite sides of bridge 212 relative to one another.

In some examples, artificial-reality device 600 may include and/or represent current breaks 604(1)-(2) that reduce and/or decrease the amount of current that flows along temples 204(1)-(2), respectively. In one example, current breaks 604(1)-(2) may each include and/or represent an electrical discontinuity, disconnect, and/or dielectric along temples 204(1)-(2), respectively. In this example, current breaks 604(1)-(2) may be formed in, created in, and/or applied to temples 204(1)-(2), respectively. Additionally or alternatively, current breaks 604(1)-(2) may be positioned and/or placed near and/or proximate to hinges, such as hinge 504, on temples 204(1)-(2).

In some examples, current breaks 604(1)-(2) may be placed and/or positioned to reduce and/or mitigate the amount of electric current that passes through temples 204(1)-(2), respectively. By reducing and/or mitigating the amount of electric current in this way, current breaks 604(1)-(2) may effectively reduce and/or mitigate the amount of RF radiation absorbed by the user's head from the electric current passing through temples 204(1)-(2). Additionally or alternatively, such placements and/or positions may increase and/or improve the performance and/or efficiency of the antennas.

In some examples, artificial-reality device 600 may integrate and/or incorporate at least 6 or 7 antennas that collectively support a variety of different wireless technologies. For example, artificial-reality device 600 may include and/or represent WI-FI antennas integrated into temples 204(1)-(2), a BLUETOOTH antenna integrated into one of temples 204(1)-(2), cellular antennas integrated into rim 202 and optical elements 206(1)-(2), and/or a GNSS antenna integrated into rim 202. In another example, artificial-reality device 600 may include and/or represent WI-FI antennas integrated into temples 204(1)-(2) and rim 202, BLUETOOTH antennas integrated into rim 202, cellular antennas integrated into rim 202 and optical elements 206(1)-(2), and/or a GNSS antenna integrated into rim 202. In certain implementations, some of these antennas may be consolidated if a single antenna is able to support multiple technologies (e.g., BLUETOOTH and WI-FI at 2.4 gigahertz). In other words, a single antenna may support and/or be shared by multiple technologies.

In some examples, the WI-FI antennas may be designed, configured, and/or deployed to transmit and/or receive RF signals in the 2.4-gigahertz band, 5-gigahertz band, and/or 6-gigahertz band. In one example, the BLUETOOTH antennas may be designed, configured, and/or deployed to transmit and/or receive RF signals in the 2.4-gigahertz band. Additionally or alternatively, the GNSS antenna may be designed, configured, and/or deployed to transmit and/or receive wireless signals in the L-band frequencies between 1.1 gigahertz and 1.6 gigahertz (e.g., the 1.2-gigahertz band and/or the 1.5-gigahertz band).

In some examples, the cellular antennas may be designed, configured, and/or deployed to transmit and/or receive RF signals in the low-band, mid-band, high-band, and/or ultra-high-band frequencies. For example, one or more of the cellular antennas may be designed, configured, and/or deployed to transmit and/or receive RF signals in the low-band frequencies between 600 megahertz and 1 gigahertz. In one example, one or more of the cellular antennas may be designed, configured, and/or deployed to transmit and/or receive RF signals in the mid-band and/or high-band frequencies between 1.7 gigahertz and 2.7 gigahertz. Additionally or alternatively, one or more of the cellular antennas may be designed, configured, and/or deployed to transmit and/or receive RF signals in the ultra-high-band frequencies between 3.3 gigahertz and 5.0 gigahertz.

In some examples, the various devices and systems described in connection with FIGS. 1-6 may include and/or represent one or more additional circuits, components, and/or features that are not necessarily illustrated and/or labeled in FIGS. 1-8. For example, the artificial-reality devices in FIGS. 1-6 may also include and/or represent additional analog and/or digital circuitry, onboard logic, transistors, RF transmitters, RF receivers, transceivers, antennas, resistors, capacitors, diodes, inductors, switches, registers, flipflops, connections, traces, buses, semiconductor (e.g., silicon) devices and/or structures, processing devices, storage devices, circuit boards, sensors, packages, substrates, housings, combinations or variations of one or more of the same, and/or any other suitable components that facilitate and/or support multiple wireless technologies. In certain implementations, one or more of these additional circuits, components, and/or features may be inserted and/or applied between any of the existing circuits, components, and/or features illustrated in FIGS. 1-6 consistent with the aims and/or objectives described herein. Accordingly, the couplings and/or connections described with reference to FIGS. 1-6 may be direct connections with no intermediate components, devices, and/or nodes or indirect connections with one or more intermediate components, devices, and/or nodes.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components.

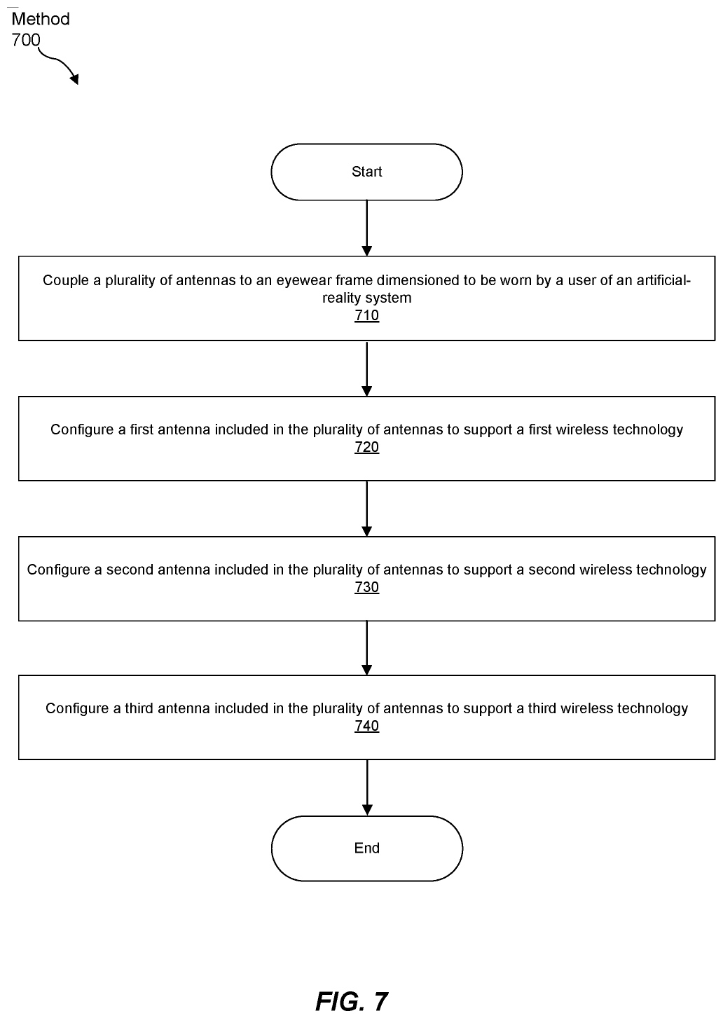

FIG. 7 is a flow diagram of an exemplary method 700 for integrating antennas that support multiple wireless technologies into eyewear frames of artificial-reality devices. In one example, the steps shown in FIG. 7 may be performed during the manufacture and/or assembly of an artificial-reality device. Additionally or alternatively, the steps shown in FIG. 7 may incorporate and/or involve various sub-steps and/or variations consistent with one or more of the descriptions provided above in connection with FIGS. 1-6.

As illustrated in FIG. 7, method 700 may include and/or involve the step of coupling a plurality of antennas to an eyewear frame dimensioned to be worn by a user of an artificial-reality system (710). Step 710 may be performed in a variety of ways, including any of those described above in connection with FIGS. 1-6. For example, an AR equipment manufacturer or subcontractor may couple, embed and/or integrate a plurality of antennas into the frame of AR eyeglasses dimensioned to be worn by a user.

In some examples, method 700 may also include the step of configuring a first antenna included in the plurality of antennas to support a first wireless technology (720). Step 720 may be performed in a variety of ways, including any of those described above in connection with FIGS. 1-6. For example, the AR equipment manufacturer or subcontractor may design, configure, and/or deploy one or more of the antennas in the frame of the AR eyeglasses to support a certain wireless technology. In one example, this wireless technology may include and/or represent cellular circuitry and/or communications.

In some examples, method 700 may also include the step of configuring a second antenna included in the plurality of antennas to support a second wireless technology (730). Step 730 may be performed in a variety of ways, including any of those described above in connection with FIGS. 1-6. For example, the AR equipment manufacturer or subcontractor may design, configure, and/or deploy one or more of the antennas in the frame of the AR eyeglasses to support another wireless technology. In one example, this other wireless technology may include and/or represent WI-FI circuitry and/or communications.

In some examples, method 700 may also include the step of configuring a second antenna included in the plurality of antennas to support a third wireless technology (740). Step 740 may be performed in a variety of ways, including any of those described above in connection with FIGS. 1-6. For example, the AR equipment manufacturer or subcontractor may design, configure, and/or deploy one or more of the antennas in the frame of the AR eyeglasses to support a different wireless technology. In one example, this different wireless technology may include and/or represent BLUETOOTH circuitry and/or communications.

### EXAMPLE EMBODIMENTS

Example 1: An artificial-reality device comprising (1) an eyewear frame dimensioned to be worn by a user and (2) a plurality of antennas coupled to the eyewear frame, wherein the plurality of antennas comprise (A) a first antenna configured to support a first wireless technology, (B) a second antenna configured to support a second wireless technology, and (C) a third antenna configured to support a third wireless technology.

Example 2: The artificial-reality device of Example 1, further comprising at least one optical element coupled to the eyewear frame and configured to provide one or more virtual features for presentation to the user in connection with the first wireless technology, the second wireless technology, or the third wireless technology.

Example 3: The artificial-reality device of either Example 1 or Example 2, wherein the plurality of antennas further comprise a fourth antenna configured to support a fourth wireless technology.

Example 4: The artificial-reality device of any of Examples 1-3, wherein (1) the first wireless technology comprises cellular communications, (2) the second wireless technology comprises wireless local area network (LAN) communications, (3) the third wireless technology comprises short-range communications distinct from the cellular communications and the wireless LAN communications, and/or (4) the fourth wireless technology comprises satellite communications.

Example 5: The artificial-reality device of any of Examples 1-4, wherein (1) the first antenna is at least partially incorporated in a rim of the eyewear frame, (2) the second antenna is at least partially incorporated in a temple of the eyewear frame, (3) the third antenna is at least partially incorporated in an optical element coupled to the eyewear frame, and/or (4) the fourth antenna is at least partially incorporated in the rim of the eyewear frame.

Example 6: The artificial-reality device of any of Examples 1-5, wherein (1) the first antenna comprises a segment of the rim, (2) the second antenna is housed in a corner of the eyewear frame formed by the temple and the rim, (3) the third antenna comprises a transparent conductive layer included in the optical element, and/or (4) the fourth antenna comprises another segment of the rim.

Example 7: The artificial-reality device of any of Examples 1-6, wherein the rim comprises (1) a feed break that separates the segment of the rim from a ground reference, and (2) a tuning break that facilitates exciting a certain mode for the first antenna.

Example 8: The artificial-reality device of any of Examples 1-7, wherein the feed break is formed along an outer middle section of the rim proximate to an endpiece of the eyewear frame.

Example 9: The artificial-reality device of any of Examples 1-8, wherein the tuning break is formed along an inner top section of the rim proximate to a nose pad of the eyewear frame.

Example 10: The artificial-reality device of any of Examples 1-9, wherein the tuning break is formed along an inner bottom section of the rim between a nose pad of the eyewear frame and the feed break.

Example 11: The artificial-reality device of any of Examples 1-10, wherein the tuning break is formed along a middle bottom section of the rim between a nose pad of the eyewear frame and the feed break.

Example 12: The artificial-reality device of any of Examples 1-11, wherein the temple comprises a current break that reduces current flow in the temple.

Example 13: The artificial-reality device of any of Examples 1-12, wherein the current break is formed in the temple proximate to a hinge of the eyewear frame.

Example 14: The artificial-reality device of any of Examples 1-13, wherein (1) the first antenna is tuned to support at least a portion of low-band frequencies between 600 megahertz and 1 gigahertz, (2) the second antenna is tuned to support a 2.4-gigahertz band or a 5-gigahertz band, (3) the third antenna is tuned to support at least a portion of mid-band frequencies between 1.7 gigahertz and 2.7 gigahertz, and (4) the fourth antenna is tuned to support at least a portion of L-band frequencies between 1.1 gigahertz and 1.6 gigahertz.

Example 15: The artificial-reality device of any of Examples 1-14, wherein the plurality of antennas further comprise a fifth antenna configured to support a fifth wireless technology.

Example 16: The artificial-reality device of any of Examples 1-15, wherein the fifth antenna is tuned to support at least portion of ultra-high-band frequencies between 3.3 gigahertz and 5 gigahertz.

Example 17: The artificial-reality device of any of Examples 1-15, wherein the plurality of antennas comprises a total of at least 6 antennas.

Example 18: A system comprising (1) a computing device and (2) an artificial-reality device communicatively coupled to the computing device, the augmented-reality headset comprising (A) an eyewear frame dimensioned to be worn by a user and (B) a plurality of antennas coupled to the eyewear frame, wherein the plurality of antennas comprise (I) a first antenna configured to support a first wireless technology, (II) a second antenna configured to support a second wireless technology, and (III) a third antenna configured to support a third wireless technology.

Example 19: The system of Example 18, further comprising at least one optical element coupled to the eyewear frame and configured to provide one or more virtual features for presentation to the user in connection with the first wireless technology, the second wireless technology, or the third wireless technology.

Example 20: A method comprising (1) coupling a plurality of antennas to an eyewear frame dimensioned to be worn by a user of an artificial-reality system, (2) configuring a first antenna included in the plurality of antennas to support a first wireless technology, (3) configuring a second antenna included in the plurality of antennas to support a second wireless technology, and (4) configuring a third antenna included in the plurality of antennas to support a third wireless technology.

Embodiments of the present disclosure may include or be implemented in conjunction with various types of artificial-reality systems. Artificial reality is a form of reality that has been adjusted in some manner before presentation to a user, which may include, for example, a VR, an AR, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

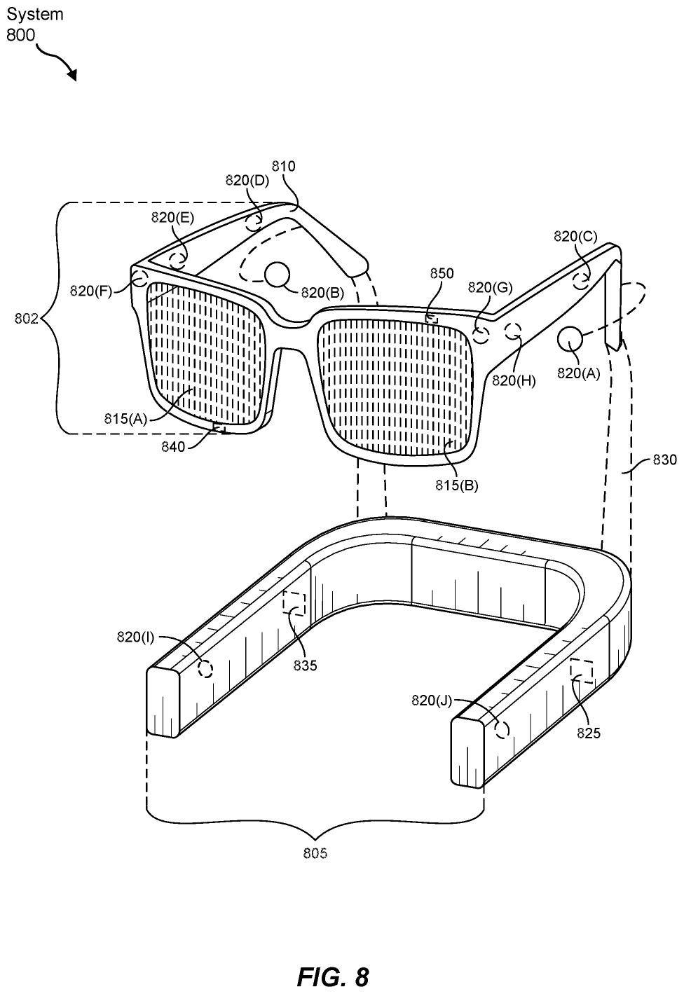

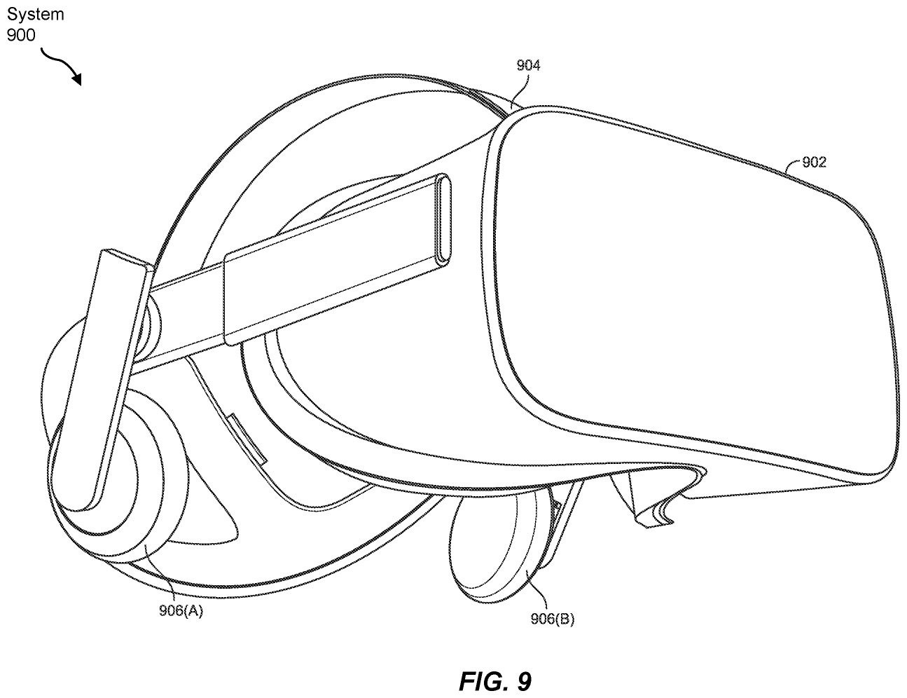

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., AR system 800 in FIG. 8) or that visually immerses a user in an artificial reality (such as, e.g., VR system 900 in FIG. 9). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 8, AR system 800 may include an eyewear device 802 with a frame 810 configured to hold a left display device 815(A) and a right display device 815(B) in front of a user's eyes. Display devices 815(A) and 815(B) may act together or independently to present an image or series of images to a user. While AR system 800 includes two displays, embodiments of this disclosure may be implemented in AR systems with a single NED or more than two NEDs.

In some embodiments, AR system 800 may include one or more sensors, such as sensor 840. Sensor 840 may generate measurement signals in response to motion of AR system 800 and may be located on substantially any portion of frame 810. Sensor 840 may represent one or more of a variety of different sensing mechanisms, such as a position sensor, an inertial measurement unit (IMU), a depth camera assembly, a structured light emitter and/or detector, or any combination thereof. In some embodiments, AR system 800 may or may not include sensor 840 or may include more than one sensor. In embodiments in which sensor 840 includes an IMU, the IMU may generate calibration data based on measurement signals from sensor 840. Examples of sensor 840 may include, without limitation, accelerometers, gyroscopes, magnetometers, other suitable types of sensors that detect motion, sensors used for error correction of the IMU, or some combination thereof.

In some examples, AR system 800 may also include a microphone array with a plurality of acoustic transducers 820(A)-820(J), referred to collectively as acoustic transducers 820. Acoustic transducers 820 may represent transducers that detect air pressure variations induced by sound waves. Each acoustic transducer 820 may be configured to detect sound and convert the detected sound into an electronic format (e.g., an analog or digital format). The microphone array in FIG. 8 may include, for example, ten acoustic transducers: 820(A) and 820(B), which may be designed to be placed inside a corresponding ear of the user, acoustic transducers 820(C), 820(D), 820(E), 820(F), 820(G), and 820(H), which may be positioned at various locations on frame 810, and/or acoustic transducers 820(1) and 820(J), which may be positioned on a corresponding neckband 805.

In some embodiments, one or more of acoustic transducers 820(A)-(J) may be used as output transducers (e.g., speakers). For example, acoustic transducers 820(A) and/or 820(B) may be earbuds or any other suitable type of headphone or speaker.

The configuration of acoustic transducers 820 of the microphone array may vary. While AR system 800 is shown in FIG. 8 as having ten acoustic transducers 820, the number of acoustic transducers 820 may be greater or less than ten. In some embodiments, using higher numbers of acoustic transducers 820 may increase the amount of audio information collected and/or the sensitivity and accuracy of the audio information. In contrast, using a lower number of acoustic transducers 820 may decrease the computing power required by an associated controller 850 to process the collected audio information. In addition, the position of each acoustic transducer 820 of the microphone array may vary. For example, the position of an acoustic transducer 820 may include a defined position on the user, a defined coordinate on frame 810, an orientation associated with each acoustic transducer 820, or some combination thereof.

Acoustic transducers 820(A) and 820(B) may be positioned on different parts of the user's ear, such as behind the pinna, behind the tragus, and/or within the auricle or fossa. Or, there may be additional acoustic transducers 820 on or surrounding the ear in addition to acoustic transducers 820 inside the ear canal. Having an acoustic transducer 820 positioned next to an ear canal of a user may enable the microphone array to collect information on how sounds arrive at the ear canal. By positioning at least two of acoustic transducers 820 on either side of a user's head (e.g., as binaural microphones), AR system 800 may simulate binaural hearing and capture a 3D stereo sound field around about a user's head. In some embodiments, acoustic transducers 820(A) and 820(B) may be connected to AR system 800 via a wired connection 830, and in other embodiments acoustic transducers 820(A) and 820(B) may be connected to AR system 800 via a wireless connection (e.g., a BLUETOOTH connection). In still other embodiments, acoustic transducers 820(A) and 820(B) may not be used at all in conjunction with AR system 800.

Acoustic transducers 820 on frame 810 may be positioned in a variety of different ways, including along the length of the temples, across the bridge, above or below display devices 815(A) and 815(B), or some combination thereof. Acoustic transducers 820 may also be oriented such that the microphone array is able to detect sounds in a wide range of directions surrounding the user wearing the AR system 800. In some embodiments, an optimization process may be performed during manufacturing of AR system 800 to determine relative positioning of each acoustic transducer 820 in the microphone array.

In some examples, AR system 800 may include or be connected to an external device (e.g., a paired device), such as neckband 805. Neckband 805 generally represents any type or form of paired device. Thus, the following discussion of neckband 805 may also apply to various other paired devices, such as charging cases, smart watches, smart phones, wrist bands, other wearable devices, hand-held controllers, tablet computers, laptop computers, other external compute devices, etc.

As shown, neckband 805 may be coupled to eyewear device 802 via one or more connectors. The connectors may be wired or wireless and may include electrical and/or non-electrical (e.g., structural) components. In some cases, eyewear device 802 and neckband 805 may operate independently without any wired or wireless connection between them. While FIG. 8 illustrates the components of eyewear device 802 and neckband 805 in example locations on eyewear device 802 and neckband 805, the components may be located elsewhere and/or distributed differently on eyewear device 802 and/or neckband 805. In some embodiments, the components of eyewear device 802 and neckband 805 may be located on one or more additional peripheral devices paired with eyewear device 802, neckband 805, or some combination thereof.

Pairing external devices, such as neckband 805, with AR eyewear devices may enable the eyewear devices to achieve the form factor of a pair of glasses while still providing sufficient battery and computation power for expanded capabilities. Some or all of the battery power, computational resources, and/or additional features of AR system 800 may be provided by a paired device or shared between a paired device and an eyewear device, thus reducing the weight, heat profile, and form factor of the eyewear device overall while still retaining desired functionality. For example, neckband 805 may allow components that would otherwise be included on an eyewear device to be included in neckband 805 since users may tolerate a heavier weight load on their shoulders than they would tolerate on their heads. Neckband 805 may also have a larger surface area over which to diffuse and disperse heat to the ambient environment. Thus, neckband 805 may allow for greater battery and computation capacity than might otherwise have been possible on a stand-alone eyewear device. Since weight carried in neckband 805 may be less invasive to a user than weight carried in eyewear device 802, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 805 may be communicatively coupled with eyewear device 802 and/or to other devices. These other devices may provide certain functions (e.g., tracking, localizing, depth mapping, processing, storage, etc.) to AR system 800. In the embodiment of FIG. 8, neckband 805 may include two acoustic transducers (e.g., 820(I) and 820(J)) that are part of the microphone array (or potentially form their own microphone subarray). Neckband 805 may also include a controller 825 and a power source 835.

Acoustic transducers 820(I) and 820(J) of neckband 805 may be configured to detect sound and convert the detected sound into an electronic format (analog or digital). In the embodiment of FIG. 8, acoustic transducers 820(I) and 820(J) may be positioned on neckband 805, thereby increasing the distance between the neckband acoustic transducers 820(I) and 820(J) and other acoustic transducers 820 positioned on eyewear device 802. In some cases, increasing the distance between acoustic transducers 820 of the microphone array may improve the accuracy of beamforming performed via the microphone array. For example, if a sound is detected by acoustic transducers 820(C) and 820(D) and the distance between acoustic transducers 820(C) and 820(D) is greater than, e.g., the distance between acoustic transducers 820(D) and 820(E), the determined source location of the detected sound may be more accurate than if the sound had been detected by acoustic transducers 820(D) and 820(E).

Controller 825 of neckband 805 may process information generated by the sensors on neckband 805 and/or AR system 800. For example, controller 825 may process information from the microphone array that describes sounds detected by the microphone array. For each detected sound, controller 825 may perform a direction-of-arrival (DOA) estimation to estimate a direction from which the detected sound arrived at the microphone array. As the microphone array detects sounds, controller 825 may populate an audio data set with the information. In embodiments in which AR system 800 includes an inertial measurement unit, controller 825 may compute all inertial and spatial calculations from the IMU located on eyewear device 802. A connector may convey information between AR system 800 and neckband 805 and between AR system 800 and controller 825. The information may be in the form of optical data, electrical data, wireless data, or any other transmittable data form. Moving the processing of information generated by AR system 800 to neckband 805 may reduce weight and heat in eyewear device 802, making it more comfortable to the user.

Power source 835 in neckband 805 may provide power to eyewear device 802 and/or to neckband 805. Power source 835 may include, without limitation, lithium ion batteries, lithium-polymer batteries, primary lithium batteries, alkaline batteries, or any other form of power storage. In some cases, power source 835 may be a wired power source. Including power source 835 on neckband 805 instead of on eyewear device 802 may help better distribute the weight and heat generated by power source 835.

As noted, some artificial-reality systems may, instead of blending an artificial reality with actual reality, substantially replace one or more of a user's sensory perceptions of the real world with a virtual experience. One example of this type of system is a head-worn display system, such as VR system 900 in FIG. 9, that mostly or completely covers a user's field of view. VR system 900 may include a front rigid body 902 and a band 904 shaped to fit around a user's head. VR system 900 may also include output audio transducers 906(A) and 906(B). Furthermore, while not shown in FIG. 9, front rigid body 902 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in AR system 800 and/or VR system 900 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in AR system 800 and/or VR system 900 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, AR system 800 and/or VR system 900 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As noted, artificial-reality systems 800 and 900 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 10 illustrates a vibrotactile system 1000 in the form of a wearable glove (haptic device 1010) and wristband (haptic device 1020). Haptic device 1010 and haptic device 1020 are shown as examples of wearable devices that include a flexible, wearable textile material 1030 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 1040 may be positioned at least partially within one or more corresponding pockets formed in textile material 1030 of vibrotactile system 1000. Vibrotactile devices 1040 may be positioned in locations to provide a vibrating sensation (e.g., haptic feedback) to a user of vibrotactile system 1000. For example, vibrotactile devices 1040 may be positioned against the user's finger(s), thumb, or wrist, as shown in FIG. 10. Vibrotactile devices 1040 may, in some examples, be sufficiently flexible to conform to or bend with the user's corresponding body part(s).

A power source 1050 (e.g., a battery) for applying a voltage to the vibrotactile devices 1040 for activation thereof may be electrically coupled to vibrotactile devices 1040, such as via conductive wiring 1052. In some examples, each of vibrotactile devices 1040 may be independently electrically coupled to power source 1050 for individual activation. In some embodiments, a processor 1060 may be operatively coupled to power source 1050 and configured (e.g., programmed) to control activation of vibrotactile devices 1040.

Vibrotactile system 1000 may be implemented in a variety of ways. In some examples, vibrotactile system 1000 may be a standalone system with integral subsystems and components for operation independent of other devices and systems. As another example, vibrotactile system 1000 may be configured for interaction with another device or system 1070. For example, vibrotactile system 1000 may, in some examples, include a communications interface 1080 for receiving and/or sending signals to the other device or system 1070. The other device or system 1070 may be a mobile device, a gaming console, an artificial-reality (e.g., VR, AR, mixed-reality) device, a personal computer, a tablet computer, a network device (e.g., a modem, a router, etc.), a handheld controller, etc. Communications interface 1080 may enable communications between vibrotactile system 1000 and the other device or system 1070 via a wireless (e.g., Wi-Fi, BLUETOOTH, cellular, radio, etc.) link or a wired link. If present, communications interface 1080 may be in communication with processor 1060, such as to provide a signal to processor 1060 to activate or deactivate one or more of the vibrotactile devices 1040.

Vibrotactile system 1000 may optionally include other subsystems and components, such as touch-sensitive pads 1090, pressure sensors, motion sensors, position sensors, lighting elements, and/or user interface elements (e.g., an on/off button, a vibration control element, etc.). During use, vibrotactile devices 1040 may be configured to be activated for a variety of different reasons, such as in response to the user's interaction with user interface elements, a signal from the motion or position sensors, a signal from the touch-sensitive pads 1090, a signal from the pressure sensors, a signal from the other device or system 1070, etc.

Although power source 1050, processor 1060, and communications interface 1080 are illustrated in FIG. 10 as being positioned in haptic device 1020, the present disclosure is not so limited. For example, one or more of power source 1050, processor 1060, or communications interface 1080 may be positioned within haptic device 1010 or within another wearable textile.

Haptic wearables, such as those shown in and described in connection with FIG. 10, may be implemented in a variety of types of artificial-reality systems and environments. FIG. 11 shows an example artificial-reality environment 1100 including one head-mounted VR display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 1102 generally represents any type or form of VR system, such as VR system 900 in FIG. 9. Haptic device 1104 generally represents any type or form of wearable device, worn by a user of an artificial-reality system, that provides haptic feedback to the user to give the user the perception that he or she is physically engaging with a virtual object. In some embodiments, haptic device 1104 may provide haptic feedback by applying vibration, motion, and/or force to the user. For example, haptic device 1104 may limit or augment a user's movement. To give a specific example, haptic device 1104 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 1104 to send action requests to a console. Examples of action requests include, without limitation, requests to start an application and/or end the application and/or requests to perform a particular action within the application.

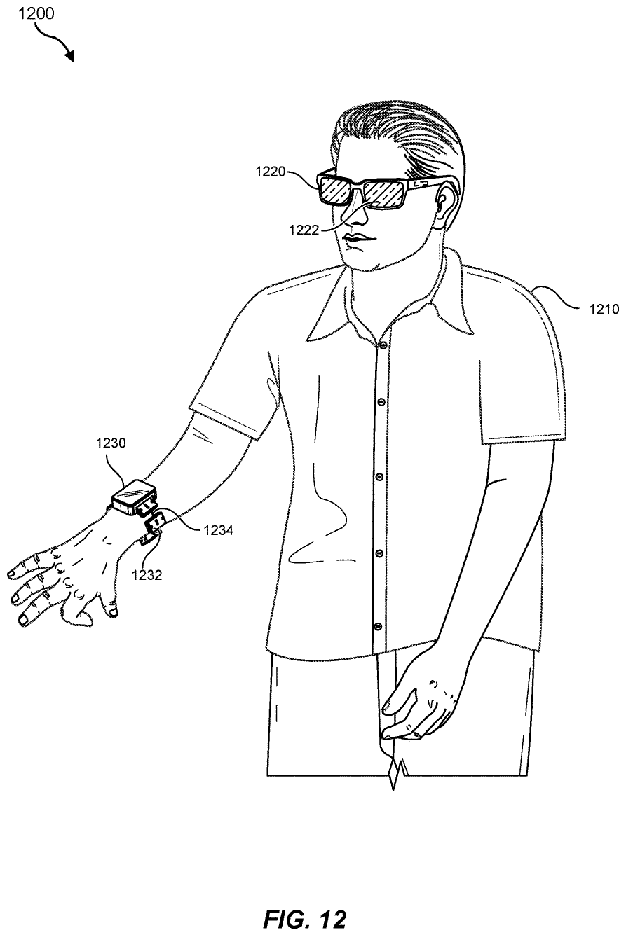

While haptic interfaces may be used with VR systems, as shown in FIG. 11, haptic interfaces may also be used with AR systems, as shown in FIG. 12. FIG. 12 is a perspective view of a user 1210 interacting with an AR system 1200. In this example, user 1210 may wear a pair of AR glasses 1220 that may have one or more displays 1222 and that are paired with a haptic device 1230. In this example, haptic device 1230 may be a wristband that includes a plurality of band elements 1232 and a tensioning mechanism 1234 that connects band elements 1232 to one another. Additionally or alternatively, haptic device 1530 may include and/or represent a haptic smartwatch and/or a smartwatch with haptic features.

One or more of band elements 1232 may include any type or form of actuator suitable for providing haptic feedback. For example, one or more of band elements 1232 may be configured to provide one or more of various types of cutaneous feedback, including vibration, force, traction, texture, and/or temperature. To provide such feedback, band elements 1232 may include one or more of various types of actuators. In one example, each of band elements 1232 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 1010, 1020, 1104, and 1230 may include any suitable number and/or type of haptic transducer, sensor, and/or feedback mechanism. For example, haptic devices 1010, 1020, 1104, and 1230 may include one or more mechanical transducers, piezoelectric transducers, and/or fluidic transducers. Haptic devices 1010, 1020, 1104, and 1230 may also include various combinations of different types and forms of transducers that work together or independently to enhance a user's artificial-reality experience. In one example, each of band elements 1232 of haptic device 1230 may include a vibrotactor (e.g., a vibrotactile actuator) configured to vibrate in unison or independently to provide one or more of various types of haptic sensations to a user.

The process parameters and sequence of the steps described and/or illustrated herein are given by way of example only and may be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. An artificial-reality device comprising:
an eyewear frame dimensioned to be worn by a user; and
a plurality of antennas coupled to the eyewear frame, wherein the plurality of antennas comprise:
a first antenna configured to support a first wireless technology;
a second antenna configured to support a second wireless technology; and
a third antenna configured to support a third wireless technology.

2. The artificial-reality device of claim 1, further comprising at least one optical element coupled to the eyewear frame and configured to provide one or more virtual features for presentation to the user in connection with the first wireless technology, the second wireless technology, or the third wireless technology.

3. The artificial-reality device of claim 1, wherein the plurality of antennas further comprise a fourth antenna configured to support a fourth wireless technology.

4. The artificial-reality device of claim 3, wherein:
the first wireless technology comprises cellular communications;
the second wireless technology comprises wireless local area network (LAN) communications;
the third wireless technology comprises short-range communications distinct from the cellular communications and the wireless LAN communications; and
the fourth wireless technology comprises satellite communications.

5. The artificial-reality device of claim 3, wherein:
the first antenna is at least partially incorporated in a rim of the eyewear frame;
the second antenna is at least partially incorporated in a temple of the eyewear frame;
the third antenna is at least partially incorporated in an optical element coupled to the eyewear frame; and
the fourth antenna is at least partially incorporated in the rim of the eyewear frame.

6. The artificial-reality device of claim 5, wherein:
the first antenna comprises a segment of the rim;
the second antenna is housed in a corner of the eyewear frame formed by the temple and the rim;
the third antenna comprises a transparent conductive layer included in the optical element; and
the fourth antenna comprises another segment of the rim.

7. The artificial-reality device of claim 6, wherein the rim comprises:
a feed break that separates the segment of the rim from a ground reference; and
a tuning break that facilitates exciting a certain mode for the first antenna.

8. The artificial-reality device of claim 7, wherein the feed break is formed along an outer middle section of the rim proximate to an endpiece of the eyewear frame.

9. The artificial-reality device of claim 7, wherein the tuning break is formed along an inner top section of the rim proximate to a nose pad of the eyewear frame.

10. The artificial-reality device of claim 7, wherein the tuning break is formed along an inner bottom section of the rim between a nose pad of the eyewear frame and the feed break.

11. The artificial-reality device of claim 7, wherein the tuning break is formed along a middle bottom section of the rim between a nose pad of the eyewear frame and the feed break.

12. The artificial-reality device of claim 7, wherein the temple comprises a current break that reduces current flow in the temple.

13. The artificial-reality device of claim 12, wherein the current break is formed in the temple proximate to a hinge of the eyewear frame.

14. The artificial-reality device of claim 7, wherein the feed break and the tuning break are positioned on the eyewear frame at locations that:
maximize distance away from a head of the user; or
reduce an amount of radio-frequency radiation that is absorbed by a head of the user.

15. The artificial-reality device of claim 3, wherein:
the first antenna is tuned to support at least a portion of low-band frequencies between 600 megahertz and 1 gigahertz;
the second antenna is tuned to support a 2.4-gigahertz band or a 5-gigahertz band;
the third antenna is tuned to support at least a portion of mid-band frequencies between 1.7 gigahertz and 2.7 gigahertz; and
the fourth antenna is tuned to support at least a portion of L-band frequencies between 1.1 gigahertz and 1.6 gigahertz.

16. The artificial-reality device of claim 15, wherein the plurality of antennas further comprise a fifth antenna configured to support a fifth wireless technology.

17. The artificial-reality device of claim 16, wherein the fifth antenna is tuned to support at least portion of ultra-high-band frequencies between 3.3 gigahertz and 5 gigahertz.

18. The artificial-reality device of claim 1, wherein the plurality of antennas comprises a total of at least 6 antennas.

19. A system comprising:
a computing device; and
an artificial-reality device communicatively coupled to the computing device, the artificial-reality device comprising:
an eyewear frame dimensioned to be worn by a user; and
a plurality of antennas coupled to the eyewear frame, wherein the plurality of antennas comprise:
a first antenna configured to support a first wireless technology;
a second antenna configured to support a second wireless technology; and
a third antenna configured to support a third wireless technology.

20. A method comprising:
coupling a plurality of antennas to an eyewear frame dimensioned to be worn by a user of an artificial-reality system;
configuring a first antenna included in the plurality of antennas to support a first wireless technology;
configuring a second antenna included in the plurality of antennas to support a second wireless technology; and
configuring a third antenna included in the plurality of antennas to support a third wireless technology.
